(19) United States
(12) Patent Application Publication
(10) Pub. No.: US 2002/0111902 A1
(43) Pub. Date: Aug. 15, 2002

(54) Method and system for game center based network good

(75) Inventors: Toshihiko Satou, Tokyo (JP); Marehito Kudou, Tokyo (JP)

Correspondence Address: GEORGE A. LOUD, 3137 MOUNT VERNON AVENUE, ALEXANDRIA, VA, 22305, US

(73) Assignee: YUUGENGAISYA YAMAGATAYASOUKEN

(21) Appl. No.: 09/779,489

(22) Filed: Feb. 9, 2001

(51) Int. Cl. G06F 17/60

(52) U.S. Cl. 705/39

(57) ABSTRACT

The present invention relates to a method and system for obtaining and exchanging goods using a network system that includes a game center based computer to assist customers of a game center. Goods can be offered to customers and allowed to be exchanged by customers via use of an account that is registered as belonging to the customer.

### TECHNICAL FIELD OF THE INVENTION

The present invention relates to a method and system for obtaining and exchanging goods using a network system that includes a game center based computer to assist customers of a game center.

### BACKGROUND OF THE INVENTION

To date customers at game centers have been unable to redeem the small amount of remaining credit that they have from a game center. This remaining credit relates to games played. The customer may wish to play later or redeem this credit in some way at a later time so there is a desire to make this credit collectable and exchangeable to receive items the Internet or a similar information carrying network.

A second problem has arisen in getting customers to come to a game center. While publicity using newspapers, fliers or the Internet is possible,an effective means for use of the Internet or wireless phones has yet to appear.

There is also a desire for obtaining information on customers of game centers. An effective data mining method or system for this purpose has yet to arise.

The present invention overcomes the aforementioned problems.

### BRIEF SUMMARY OF THE INVENTION

The present invention relates to a method and system for obtaining and exchanging goods using a network system that includes a game center based computer to assist customers of a game center.

A first objective of the present invention is to provide a way for customers of a game center to make use of their remaining credit at a game center to obtain and exchange goods.

A second objective of the present invention is to provide a way for game centers to increase their customer base.

A third objective is to allow for data mining relating to customers of game centers.

The above-stated and other objects and advantages of the present invention will become apparent from the following description when taken with accompanying drawings. It will be understood, however, that the drawings are for purposes of illustration and are not to be construed as defining the scope and limits of the invention, reference being had for the latter purpose to the claims appended hereto.

### BRIEF DESCRIPTION OF THE DRAWINGS

FIG. 1 is a block diagram of an embodiment of the present invention.

FIG. 2 is a block diagram of an embodiment of the present invention.

FIG. 3 is a block diagram of an embodiment of the present invention.

FIG. 4 is a block diagram of an embodiment of the present invention.

FIG. 5 is a block diagram of an embodiment of the present invention.

### DETAILED DESCRIPTION OF THE INVENTION

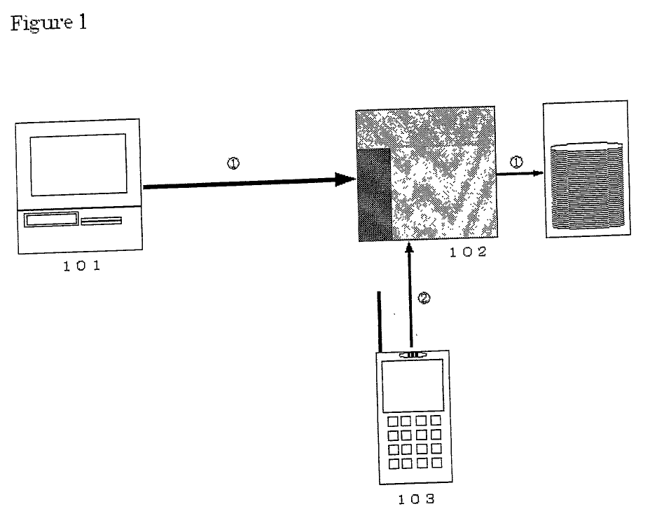

As appears in FIG. 1, in step 1, terminal 101 forms a communication link with server 102 and sends digital data representing remaining credit of a game center customer to server 102 which server 102 then saves the digital data in the form of an account to a memory or database (memory 102) accessible to server 102 (“account creation”). Terminal 101 comprises any commercially available computer with access to a memory and capable of connection to a communication network sending and receiving digital data. Server 102 comprises any commercially available server with access to a memory or dedicated database and capable of sending and receiving digital data. Memory 102 comprises a memory or database capable of connection with server 102 and of containing digital data. In step 2, portable computer 103 forms a communication link with server 102 and communicates to server 102 data comprising a password and ID or similar data (“account ID”) with which the owner of the account can identify themselves (“account ID creation”). Portable computer 103 comprises a portable device capable of wireless communication including a Personal Digital Assistant (PDA), cell phone or other portable device with access to a memory and capable of sharing files using i-Mode or other file-sharing platforms. According to an embodiment of the present invention portable computer 103 could be capable of communication using Bluetooth or file-sharing applications comprising i-Mode offered by NTT DoCoMo. Alternatively, in step 1 according to FIG. 1, terminal 101 can communicate to server 102 data to identify the owner of the account as requested by the owner and thereby carry out both account creation and account ID creation. Then in step 2, the owner could make use of server 102 to control transactions relating to their account comprising obtaining or exchanging of goods or other transactions once providing account ID to server 102. For example, though there are many other embodiments of the present invention, in step 2 the owner could provide shipping data for goods to which their account entitles them. Further, by way another example only, the owner could wait until they accrue a number of goods in their account by repeated occurrences of step 1 and then decide to exchange the goods that have accrued in their account for other goods available from or through server 102.

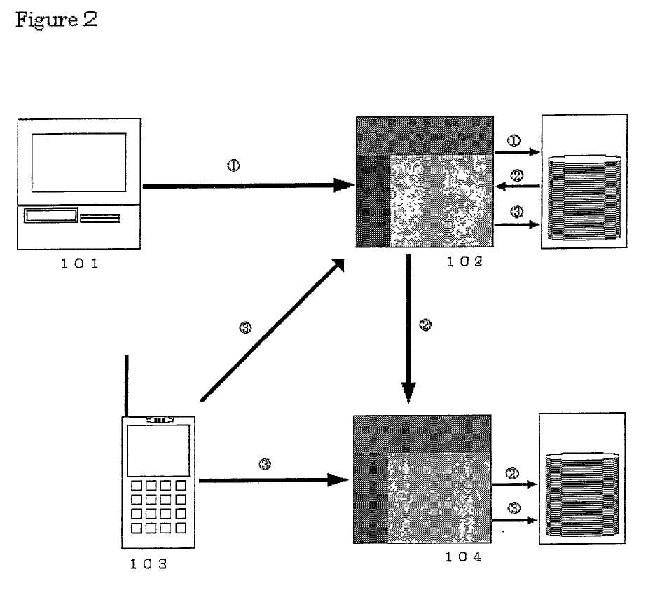

As appears in FIG. 2, according to an embodiment of the present invention, following account creation and account ID creation in step 1 of FIG. 2, in step 2, server 102 accesses memory 102, retrieves data, and forms a communication link with server 104 and transfers data relating to the owner account registered in step 1 (“account data transfer”). Server 104 comprises a server similar to server 102. Server 104 then accesses memory 104 to record the transferred data. Memory 104 comprises a memory or database capable of connection with server 104 and of containing digital data. In such way, the owner account can be maintained at either or both of server 102 and server 104, including recognition of account ID. In step 3 of FIG. 2, portable computer 103 forms a communication link with either server 102 or server 104 to utilize the credit in the owner account and obtain or exchange goods. In this way, the owner, a customer at a game center can make use of remaining game related credit to obtain goods or exchange them. The present invention does not require that account data transfer include erasure of account data at server 102, in other words the transfer is of data but not necessarily the account unless server 102 is programmed or instructed to do so.

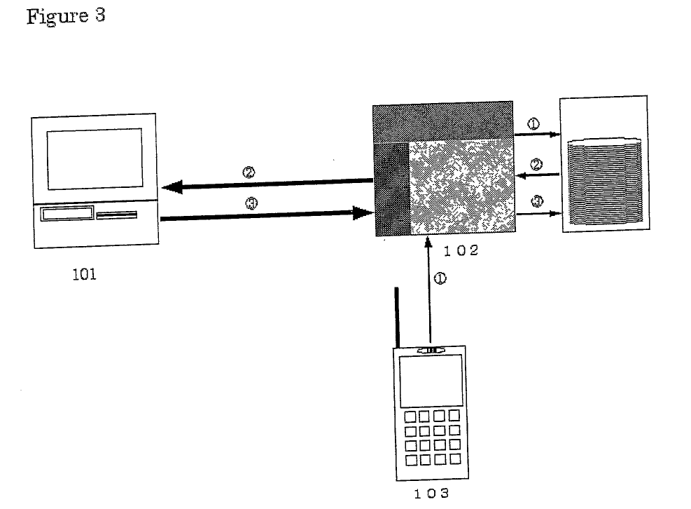

As appears in FIG. 3, following account creation and account ID creation, portable computer 103 in step 1 for FIG. 3 can form a communication link with server 102 and convey data that is relayed to terminal 101, comprising any data, for example and example only, a request that goods equal to those covered by the owner account be shipped (“shipping instructions”) to a certain address that portable computer 103 inputs. This data is stored to memory 102 by server 102. In step 2, either periodically or immediately server summons shipping instructions from memory 102 and relays shipping instructions to terminal 101. In step 3, terminal 101 then indicates to server 102 that shipping has been carried out and to decrease the owner account equal to any item shipped. In an alternative embodiment of the present invention, any data received in step 1 of FIG. 3 can be relayed to terminal 101 as a way of data mining. In this way terminal 101 can receive data that is important to their marketing strategies or business in general.

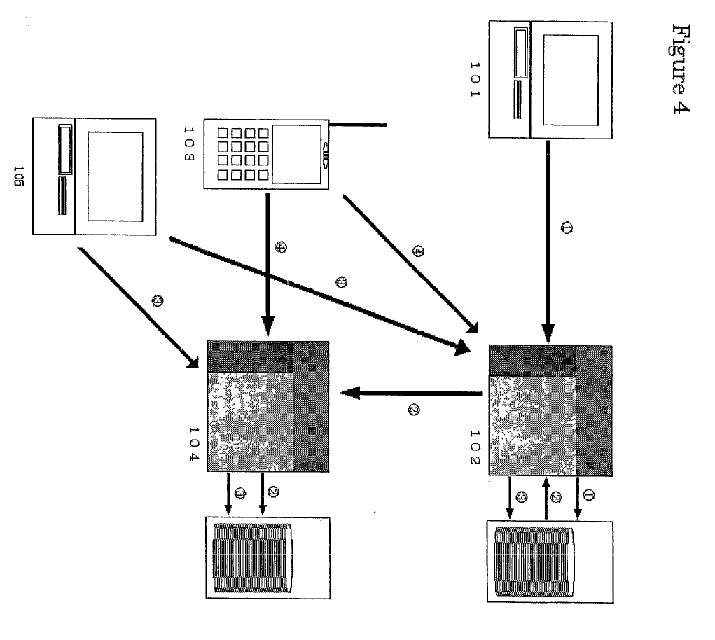

According to another embodiment of the present invention, as appears in FIG. 4, assuming account creation in step 1 and account data transfer in step 2, in step 3, terminal 105 forms communication links with either server 102 or server 104 to indicate what goods they wish to make available to account owners. Terminal 105 comprises any device similar to terminal 101. In step 4, portable computer 103 can then form a communication link with server 102 or server104 to see what goods are available to transfer their game related credit for and then select any goods that their account can cover. In this way, goods can be offered by various companies for distribution to certain customers comprising customers of game centers or other account owners. Actual orders for goods may be communicated to terminal 105 according to an embodiment of the present invention as explained as to FIG. 3 or in other ways.

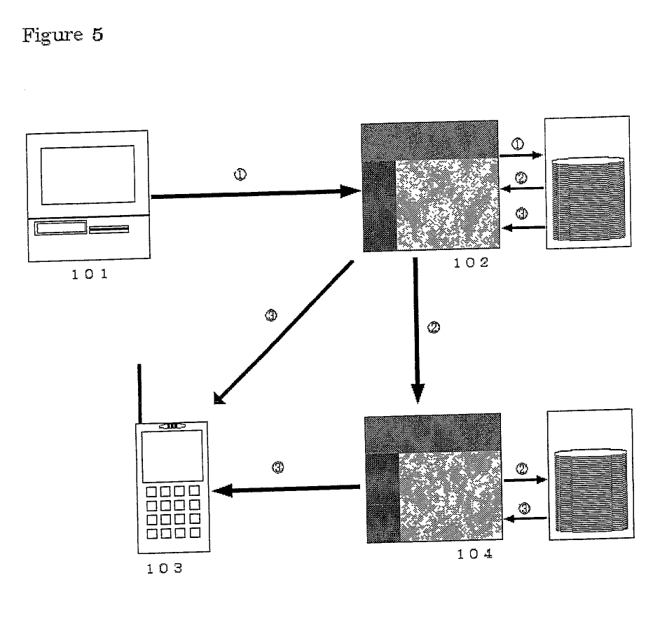

According to an embodiment of the present invention, as appears in FIG. 5, following account creation, in step 1, terminal 101 communicates to server 102 data to convey to any portable computer 103. In the event that server 102 is instructed or programmed to forward data to server 104, then step 2 takes place in which the data originally received from terminal 101 is forwarded to server 104 by server 102 and recorded by server 104 to memory 104. The data may include announcement of the opening of a new game center or other advertising data. In step 3, server 102 or server 104 can forward this data to portable computer 103 for the user of portable computer 103 to be able to review. Because the owner of portable computer 103 has been to a game center, perhaps including the game center of terminal 101, such advertising is far more likely to draw customers than general advertising. In this way, the objective of drawing more customers to game centers can be achieved. In an alternative embodiment of the present invention, if allowed to do so by server 102 or server 104, terminal 105 could also communicate data for distribution to portable computer 103 by sending such data to server 102 or server 104. In this way various companies could advertise using the present invention if they agree to do so.

According to any embodiment of the present invention i-Mode may be used as a file sharing application to communicate with portable computer 103, Wireless Application Protocol (“WAP”) may be used as a communication protocol for portable computer 103 or Bluetooth may be used to communicate with portable computer 103 as well.

What is claimed is:

1. A method for accumulating and exchanging game related credit comprising:
registering a first credit account to a first memory accessible a first server; and
registering credit to said account
wherein said step of registering can take place many times.

2. The method of claim 1 wherein said step of registering further comprises:
assigning a password and account number to said first credit account.

3. The method of claim 2 wherein further comprising:
sending said password and said account number to said first server;
sending information identifying a second credit account;
decreasing said first credit account
wherein credit can be transferred from said first credit account to said second credit account.

4. The method of claim 2 wherein further comprising:
sending data on said first credit account to a second server; and
recording said data on said account to a second server memory
wherein said second server can assist in carrying out transactions relating to said first credit account.

5. The method of claim 4 wherein further comprising:
sending product related data to said second server by a first computer
wherein said second server can offer new products to users of said second server.

6. The method of claim 5 wherein further comprising:
sending an order to said second server including delivery information;
providing said password and said account number to said second server;
decreasing said account in the amount set for such product;
registering said order in a second account of a sponsor of said product; and
indicating to said first computer said order and said delivery information.

7. The method of claim 2 wherein further comprising:
sending product related data to said first server by a first computer
wherein said first server can offer new products to users of said first server.

8. The method of claim 7 wherein further comprising:
sending an order to said first server including any delivery information;
providing said password and said account number to said first server;
decreasing said account in the amount set for such product;
registering said order in a second account of a sponsor of said product; and
indicating to said first computer said order and said any delivery information.

9. The method of claim 8 wherein further comprising in the step of said sending an order no delivery information being given:
registering ownership of said product as being said account; and,
allowing said account to transfer ownership
wherein said transfer of ownership may take place following providing delivery information relating to the recipient of said transfer or following providing information identifying a third account to become owner.

10. A system for accumulating and exchanging game related credit comprising:
a first computer;
a first server; and
a first server memory
wherein said first computer is capable of communicating with said first memory to create a credit account in said first memory and record credit to said account.

11. The system of claim 10 wherein further comprising:
a second server; and
a second server memory
wherein said second server is capable of communicating with said first server and receiving and sending data from and to said first server and said second server capable of recording data to and sending data from said second server memory.

12. The system of claim 11 wherein further comprising:
a second computer
wherein said computer is portable and capable of wireless communication with said first server and said second server, if said second server is used, for purposes of confirming any recorded credit in a certain said account and ordering said credit be used in the purchase of a product of some kind.

13. The system of claim 11 wherein further comprising:
a third computer
wherein said third computer is capable of communicating with said second server to indicate any products for said first server or said second server to offer for a set amount of credit.

14. The system of claim 12 wherein further comprising said wireless communication making use of i-Mode.

15. The system of claim 12 wherein further comprising said wireless communication making use of Bluetooth.
